(19) United States
(12) Patent Application Publication
(10) Pub. No.: US 2024/0320964 A1
(43) Pub. Date: Sep. 26, 2024

(54) SYSTEM AND METHOD FOR CLASS-IDENTITY-PRESERVING DATA AUGMENTATION

(71) Applicant: CARNEGIE MELLON UNIVERSITY, Pittsburgh, PA (US)

(72) Inventors: Marios Savvides, Pittsburgh, PA (US); Yutong Zheng, Pittsburgh, PA (US); Yu Kai Huang, Pittsburgh, PA (US)

(21) Appl. No.: 18/259,477

(22) PCT Filed: Feb. 9, 2022
(86) PCT No.: PCT/US2022/015806

§ 371 Date: Jun. 27, 2023

Related U.S. Application Data
(60) Provisional application No. 63/149,388, filed on Feb. 15, 2021.

(51) Int. Cl. G06V 10/82; G06V 40/16

(52) U.S. Cl. CPC G06V 10/82; G06V 40/172

(57) ABSTRACT

Disclosed herein is a system and method for data augmentation for general object recognition which preserves the class identity of the augmented data. The system comprises an image recognition network an image generation network that take as input ground truth images and classes respectively and which generates a predicted class and an augmented image. A discriminator evaluates the predicted class and augmented image and provides feedback to the image recognition network and the image generation network.

### RELATED APPLICATIONS

This application claims the benefit of U.S. Provisional Patent Application No. 63/149,388, filed Feb. 15, 2021, the contents of which are incorporated herein in their entirety.

### BACKGROUND

Deep neural networks with large-scale training are an efficient solution for many different applications, such as image classification, object detection and image segmentation. One crucial issue in the training of deep neural networks is the overfitting problem. In a deep neural network with a large number of parameters, generalization of the training dataset must be considered because the training of parameters could easily become fitted to the limited training dataset.

Data augmentation is an efficient method to introduce variations in the training dataset during training, thereby increasing the size of the training dataset. Using data augmentation, the size of a training dataset for a neural network can be increased by introducing copies of existing training data that have been slightly modified or by creating synthetic training data from existing training data that are then added to the training dataset. The augmented dataset acts thereby as a regularizer and helps to reduce the overfitting problem.

Data augmentation may take many forms. For example, objects may be deformed, skewed, rotated or mirrored. In addition, semantic features such as pose, lighting, shape and texture may be modified by various means.

### SUMMARY

Disclosed herein is a system and method for data augmentation for general object recognition which preserves the class identity of the augmented data. In one instance, where facial images are the objects, the system is conditioned on the identity of the person and changes are made to other facial semantics, such as pose, lighting, expression, makeup, etc. to achieve a better accuracy in model performance. The method sheds light on related AI problems such as insufficiency of available training images and privacy concerns over the training data. This method enables the training for in-the-wild recognition systems with only limited available data to create large scale photorealistic synthetic datasets that can be used for training any neural network.

### BRIEF DESCRIPTION OF THE DRAWINGS

By way of example, a specific exemplary embodiment of the disclosed system and method will now be described, with reference to the accompanying drawings, in which:

FIG. 1 is a block diagram illustrating a system to be trained.

FIG. 2 is a block diagram of the discriminator used in the training of the system of FIG. 1.

### DETAILED DESCRIPTION

The system and method of the disclosed invention will be explained in the context of a facial image generator that is to be trained to generate “real” facial images in “real” classes. In this context, “real” facial images may be images that are acceptably photorealistic faces, while “real” classes are classes of facial images that the generator has been trained to generate. For example, the facial image generator may have been trained to generate faces with or without glasses, with or without facial hair, having hair of different colors, etc. In addition, the facial image generator may have been trained to generate images in classes representing semantic features such as pose, lighting, expression, makeup, etc. As would be realized by one of skill in the art, the method may be used on an image generator for generating images depicting classes of objects other than facial images.

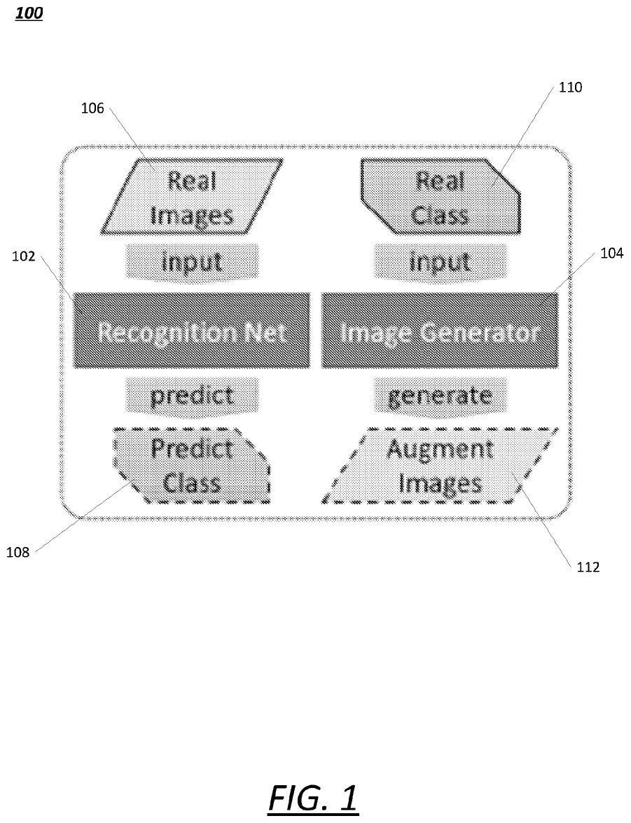

FIG. 1 is a block diagram of the system to be trained. The system consist of a image recognition network 102 which is a classifier which may be implemented as, for example, a deep neural network, and an image generation network 104 which may be, for example, a generative adversarial network (GAN). Image recognition network 102, given a real image 106 of an object (e.g., a face), predicts one or more classes 108 to which the object belongs. The image generation network 104, given one or more real classes 110, generates an augmented image 112 having the features specified by the real class 120. Preferably, the real image 106 input to recognition network 102 and the real class 110 input to image generator 104 will be ground truth inputs wherein the real image 106 exhibits the real class 110.

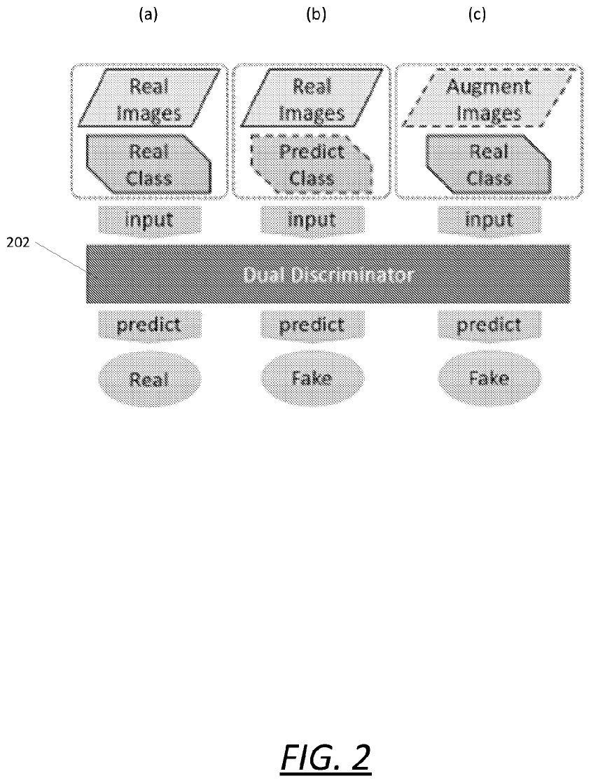

FIG. 2 is a block diagram showing discriminator 202. Discriminator 202 takes two inputs: (1) images generated by the image generation network 104; and (2) a classification of the image generated by the image generation network 104, as predicted by the recognition network 102.

Discriminator 202 is responsible for determining the authenticity of the generated images and predicted classes according to both their quality and identity preservation, and punishing the image recognition network 102 and/or the image generation network 104. That is, if the image input to discriminator 202 is not photorealistic (quality) or the predicted class input to discriminator 202 is not accurate (identity preservation), discriminator 202 will determine a “fake” outcome and will punish the image generation network 104 and/or the image recognition network 102 to make them more accurate. Over time, as image recognition network 102 and image generation network 106 become more and more accurate, the punishment becomes weaker.

Given the two inputs, discriminator 202 may return one of two results, either a “real” determination or a “fake” determination. FIG. 2(a) is an example of discriminator 202 returning a “real” result based a determination that the generated image and predicted class input to discriminator 202 are both real. FIG. 2(b) shows one case wherein discriminator 202 returns a fake result based on a determination that the generated image input to discriminator 202 is a real image, but the predicted class is fake (i.e., inaccurate). Lastly, FIG. 2(c) shows the case wherein discriminator 202 returns a fake result based on a low-quality (i.e., “fake”) image generated by image generation network 104 and a real class as generated by image recognition network 102.

As previously stated, when a “real” result is returned, the image generation network 104 and recognition network 102 will not be punished, while a “fake” output of discriminator 202 will result in image generation 104 and/or recognition network 102 being punished. The punishment may be in the form of gradient to be backpropagated to the various layers of the respective networks.

In addition to generating images exhibiting the real class 110, image generation network 104 may take as additional input noise to be applied by the image generation network 104 to further boost the variability of the output of image generation network 104, even with a pre-specified real class 110. That is, class independent semantics may be explicitly introduced into the generation. In the special case of face recognition, while the networks have been conditioned on facial identities, other semantics such as pose, lighting, expression, makeup, etc. can still vary independently. As such, image generation network 104 is encouraged to render images with large variations on which the image recognition network 102 trains. This is the key goal of data augmentation.

Taking face recognition as an example, after training, image generation network 104 will be able to generate photorealistic images with a given identity, while the generated images are expected to exhibit large variations among multiple facial semantics such as pose, lighting, expression, etc. Using facial semantic disentanglement methods, the system 100 can also generate desired faces with desired facial semantics, for example, a 60 degree left yaw angle of a face with glasses and exhibiting a smiling expression.

As would be realized by one of skill in the art, the disclosed system 100 described herein can be implemented by a system further comprising a processor and memory, storing software that, when executed by the processor, implements the soft components comprising system 100.

As would further be realized by one of skill in the art, many variations on implementations discussed herein which fall within the scope of the invention are possible. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A system comprising:
an image recognition network which takes a real image as input and predicts a class of the image;
an image generation network which takes a real class as input and generates an image fitted to the input class; and
a discriminator network which takes as input the generated image and the predicted class and returns a result indicating whether the predicted class is accurate, and the generated image is of an acceptable quality.

2. The system of claim 1 wherein the real image input to the image recognition network and the real class input to the image generation network are ground truth inputs, wherein the real image input to the image recognition network exhibits features of the real class input to the image generation network.

3. The system of claim 2 wherein the discriminator network punishes the image recognition network and/or the image generation network based on an output of the discriminator network.

4. The system of claim 3 wherein the discriminator network returns a real result if the generated image input is real and the predicted class input is real.

5. The system of claim 3 wherein the discriminator network returns a fake result if the generated input image is real and the predicted class input is fake.

6. The system of claim 3 wherein the discriminator network returns a fake result if the generated input image is fake and the predicted class input is real.

7. The system of claim 3 wherein the discriminator network punishes the recognition network if the discriminator network returns a fake result based on the predicted class input being fake.

8. The system of claim 3 wherein the discriminator network punishes the image generation network if the discriminator network returns a result based on the generated input image being fake.

9. The system of claim 3 wherein the discriminator network generates a gradient to be backpropagated to the image recognition network and/or the image generation network as the punishment.

10. The system of claim 1 wherein the image generation network takes as additional input random noise to introduce class independent semantic variations into the generated image.

11. The system of claim 1 wherein the image is generated by the image generation network are used to train the image recognition network.

12. The system of claim 1 wherein objects recognized by image recognition network in the real input image are facial images.

13. The system of claim 12 wherein the facial images are generated by image generation network and preserve a class identity of the face depicted in the facial image.

14. The system of claim 1 further comprising:
a processor;
memory, storing software that, when executed by the processor, implement the image recognition network, the image generation network, and the discriminator network.
